(19) United States
(12) Patent Application Publication
(10) Pub. No.: US 2023/0398473 A1
(43) Pub. Date: Dec. 14, 2023

(54) FILTER SUPPORT SYSTEM

(71) Applicant: Clean Air-Engineering - Maritime, Inc., San Pedro, CA (US)

(72) Inventor: Nicholas G. Tonsich, San Pedro, CA (US)

(21) Appl. No.: 18/209,985

(22) Filed: Jun. 14, 2023

Related U.S. Application Data
(60) Provisional application No. 63/352,167, filed on Jun. 14, 2022.

(51) Int. Cl. B01D 29/13

(52) U.S. Cl. CPC B01D 29/13; B01D 2201/0461; B01D 2201/34; B01D 2201/304

(57) ABSTRACT

A filter support system is provided for reducing damage to filter elements. The filter support system includes an upper support system and a lower support system for supporting at least one filter element in a vertical orientation by engaging the top and bottom of the at least one filter element. The upper support system includes a sleeve for engaging the top of the at least one filter element and the lower support system includes a compression spring that supports the at least one filter element against the upper support system.

### CROSS REFERENCE TO RELATED APPLICATIONS

This application claims priority to U.S. Provisional Application Ser. No. 63/352,167, titled Filter Support System, filed on Jun. 14, 2022, which application is incorporated herein by reference in its entirety.

### FIELD OF INVENTION

The invention relates to a support system for filters positioned inside a filter housing.

### BACKGROUND

Filters can be easily damaged by vibrations caused by surrounding operating machinery, as well as the change in orientation of the filters and/or their housings, caused by example, the use of filters at sea. Additionally, filters and their housing(s) also often take up a large amount of real estate. A need exists for a support system capable of minimizing damage to filters caused by vibrations and orientation change. A further need exists for a filter arrangement that reduces the footprint of the filters and their housing(s).

### SUMMARY

A filter support system is provided that provides support to filter elements to help reduce filter damage, such as damage that may occur to ceramic filter elements. The filter support system of the present invention includes an upper support system and a lower support system for supporting at least one filter element in a vertical orientation by engaging the top and bottom of the at least one filter element. The upper support system includes a sleeve for engaging the top of the at least one filter element and the lower support system includes a compression spring that supports the at least one filter element against the upper support system.

In one example of one implementation of the invention, the filter support system includes an upper support system sealing the top of the filter element to an upper support plate and a lower support. The lower support system includes a support frame having a filter cup positioned above the support frame for supporting the lower end of the filter element, a post extending from the lower end of the filter cup through a support frame; and a compression spring positioned around the post between the filter cup and the support frame.

In one example, the lower support system includes a support frame, a filter cup positioned above the support frame for supporting the bottom of at least one filter element, a post extending from a lower end of the filter cup through the support frame and a compression spring positioned around the post between the filter cup and the support frame. The lower support system may further include a high temperature gasket positioned in the filter cup for receiving the bottom of the at least one filter element.

The lower support system may further include an opening through which the post extends. The lower support system may then further include a hollow pin guide positioned in the opening of the support frame for allowing the post to slide through the support frame in response to movement in the compression spring.

In this example, the upper support system may further include (a) a support plate having an opening for receiving the support sleeve, where the support sleeve includes a flange surrounding the perimeter of the top of the support sleeve for resting on a top surface of the support plate; and (b) a sleeve gasket placed between the flange of the hollow filter support sleeve and the top surface of the support plate for sealing the flange member against the support plate. The sleeve gasket may be a silicon ring.

Additionally, the upper support system may further include a venturi positioned in a top opening of the support sleeve. The venturi may have a venturi flange member for resting on a top perimeter edge of the at least one filter element when positioned in the support sleeve. In other examples, a filter gasket may be positioned on the top perimeter edge of the at least one filter element. When a venturi is used, the filter gasket may be positioned between the venturi flange member and the top perimeter edge of the at least one filter element. The filter gasket may also be a silicone ring, or a sponge silicone ring. Lastly, the upper support member may further include a compression ring securing the upper support system together.

In yet another example of an implementation, the filter support system for supporting at least one filter element, the filter support system comprises an upper support system having (a) a support plate having an opening for receiving a filter support sleeve having a flange surrounding the perimeter of the top of the filter support sleeve for resting on a top surface of the support plate; and (b) a sleeve gasket placed between the flange of the filter support sleeve and the top surface of the support plate for sealing the flange member against the support plate. A venturi is then positioned in a top opening of the filter support sleeve for placement at least partially within the at least one filter element.

The system further includes a lower support that comprises a support frame; a filter cup positioned above the support frame for supporting the lower end of the filter element; a post extending from the lower end of the filter cup through a support frame; and a compression spring positioned around the post between the filter cup and the support frame. A high temperature gasket may also be positioned in the filter cup for receiving the bottom of the at least one filter element. The support frame may further include an opening through which the post extends and a hollow pin guide positioned in the opening of the support frame for allowing the post to slide through the support frame in response to movement in the compression spring.

As with the prior example, the upper support system may additionally include a venturi positioned in a top opening of the support sleeve. The venturi may have a venturi flange member for resting on a top perimeter edge of the at least one filter element when positioned in the support sleeve. In other examples, a filter gasket may be positioned on the top perimeter edge of the at least one filter element. When a venturi is used, the filter gasket may be positioned between the venturi flange member and the top perimeter edge of the at least one filter element. The filter gasket may also be a silicone ring, or a sponge silicone ring. The upper support member may further include a compression ring securing the upper support system together.

In still another example of a filter support system for supporting at least one filter element, the filter support system may include an upper support system that includes (a) a support plate having an opening for receiving a filter support sleeve having a flange surrounding the perimeter of the top of the filter support sleeve for resting on a top surface of the support plate; and (b) a venturi positioned in the filter support sleeve for placement at least partially within the at least one filter element. The filter support system may also include a lower support having a support frame; a filter support member for supporting the lower end of the filter element; and a compression spring positioned between the filter support member and the support frame.

In all cases, the support plate of the upper support system may include multiple openings for receiving a plurality of filter elements. In some examples, the multiple openings may be arranged in rows such that the openings in each row are offset from immediately bordering rows. Using such an arrangement can maximize the amount of filter elements positioned in a given space.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF FIGURES

The invention may be better understood by referring to the following figures. The components in the figures are not necessarily to scale, emphasis instead being placed upon illustrating the principles of the invention.

FIG. 1 illustrates a diagram of the filter support system of the present invention.

FIG. 2 illustrates an elevation view of the filter support system of the present invention.

FIG. 2a illustrates an enlarged view of the upper filter support system of FIG. 2.

FIG. 2b illustrates an enlarged view of the lower filter support system of FIG. 2.

FIG. 2 illustrates an elevation view of the filter support system of the present invention.

FIG. 3 illustrates an elevation view of another example of a filter support system of the present invention.

FIG. 4 illustrates an enlarged view of the upper filter support system of FIG. 3.

FIG. 5 illustrates an image of one example of the bottom of the upper filter support system of the present invention.

FIG. 6 illustrates an image of one example of the top of the upper filter support system of the present invention.

FIG. 7 illustrates a close-up image of one example of the bottom of the upper filter support system of the present invention.

FIG. 8 illustrates an image of one example of the lower filter support system of the present invention.

FIG. 9 illustrates a plan view of one example of a partial tube sheet of the invention.

FIG. 10 illustrates a plan view of another example of a partial tube sheet of the invention.

### DETAILED DESCRIPTION OF THE INVENTION

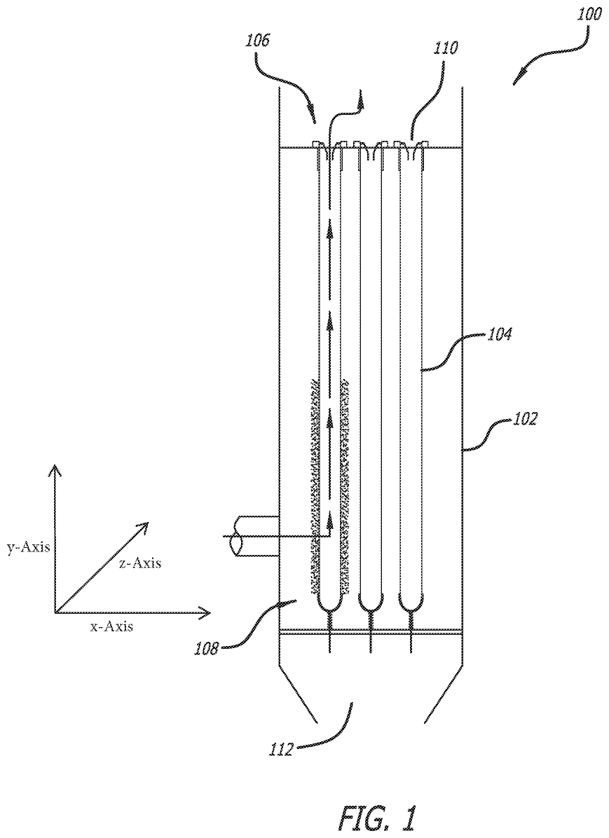

FIGS. 1-10 illustrate examples of a filter support system 100 that provides support to filters elements 104, such as ceramic filter elements, by using a novel upper support system 106 and a novel lower support system 108. While the invention can be used with other applications without departing from the scope of the invention, the present invention is useful in marine applications and, in particular, for use with filters elements 104 that filter or scrub diesel exhaust from ships.

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

In this application, the term “substantially,” “approximately,” or “about,” when modifying a specified numerical value, may be taken to encompass a range of values that include +/−10% of such numerical value. Further, such as “communicate,” and “in . . . communication with,” or “interfaces” or “interfaces with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate or interface with a second component is not intended to exclude the possibility that additional components may be present between, and/or operatively associated or engaged with, the first and second components.

For purposes of reference and description, the filter support system steamer 100 is considered to have horizontal (x-axis) and vertical device axis (y-axis) and a z-axis, as shown in FIG. 1 along which the components of the filter support system 100 are positioned relative to each other. Terms such as “axial” and “axially” are assumed to refer to the respective axis or any direction or axis parallel to the device axis, unless indicated otherwise or the context dictates otherwise. For convenience, movement relative to a device axis may alternatively encompass movement relative to an axis that is parallel to the device axis that is specifically illustrated in FIG. 1, unless the context dictates otherwise. Thus, linear translation “along the device axis z” is not limited to translation directly on (coincident with) the device axis, but also encompasses translation parallel to the device axis z, depending on the context. Similarly, rotation “about the device axis y” also encompasses rotation about an axis that is parallel to the device axis y, depending on the context.

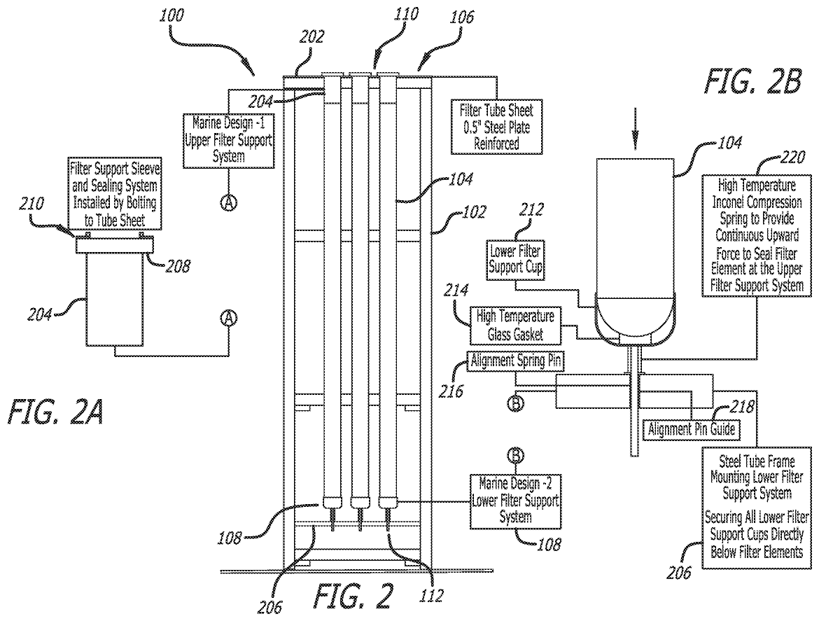

FIG. 1 is a diagram of the filter support system 100 of the present invention. As shown in FIG. 1, the filter support system 100 of the present invention is incorporated into a filter housing 102 having one or more filter elements 104 positioned within the filter housing 102. In the illustrated example, three ceramic filter elements 104 are illustrated. Diesel exhaust is vented into the filter housing 102, which, when passed through the filter elements 104, treats the exhaust gas. Treated exhaust gas then exits through the top 110 of the filter housing 102 and the waste material that cannot pass through the filter elements 104 is discharged through the bottom 112 of the filter housing 102. The filter elements 104 are supported within the filter housing 102 by an upper support system 106 and a lower support system 108. As further shown and explained below in connection with FIG. 2-8, the upper support system 106 is a clamp and seal assembly and the lower support system 108 uses a spring-based support assembly.

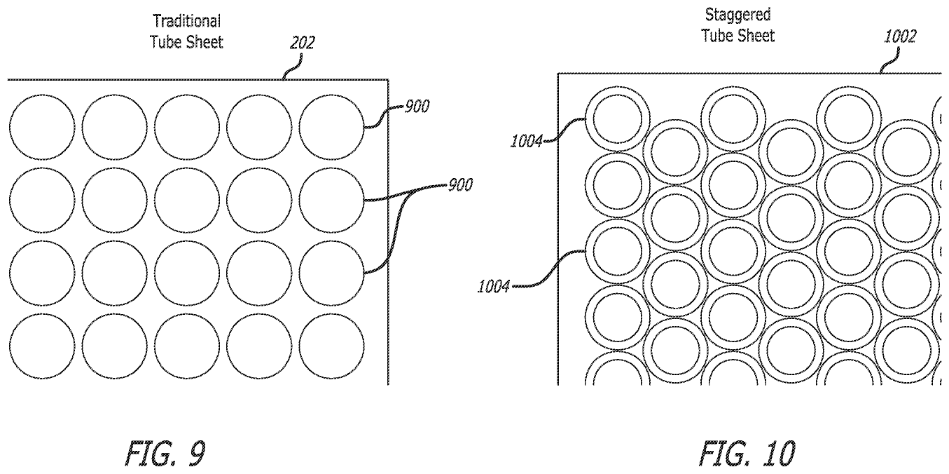

FIG. 2 is an elevation view of the filter support system 100 of the present invention. FIG. 2 shows the filter housing 102 having three ceramic filter elements 104 supported within the filter housing 102 by upper and lower supports 106, 108. The upper support 106 includes a support plate 202 having openings 900 (FIG. 9) for sleeves 204, where the sleeves 204 are positioned through the openings 900 to extend downwardly from the support plate 202 such that each sleeve 204 is adapted to receive the top of a filter element 104. In this example, the support plate 202 is an approximate 0.5 inch steel reinforced plate. However, those skilled in the art will recognize that the support plate may be of other thicknesses and materials necessary to support the filter elements 104. Similarly, the lower support 108 includes a lower support frame 206, which in the present example is a steel tube frame. While the top 110 of the filter housing 102 surrounding the filter elements 104 needs to be closed to prevent the escape of untreated gases, the lower support 108 needs to be open to allow for waste material to drop to the bottom 112 of the filter housing 102 and be discharged.

FIG. 2a is an enlarged side view of a sleeve 204, designed to engage and maintain the top of each filter 104. In this example, the support plate 202 includes openings for receiving sleeves 204 that are bolted and sealed to the support plate 202. Each sleeve 204 is hollow and sized in diameter to receive the top of a filter element 104. As further shown and described in connection with FIGS. 4 & 6, each sleeve 204 includes an upper flange member 208 having openings for securing the upper flange member 208 to the support plate 202. A sealing system 210 is also provided for preventing the escape of treated and untreated gas from the upper support system 106. Also as shown and describe in connection with FIGS. 4 & 6, the sealing system 210 includes a venturi 402 with a gasket 404 placed on top of the filter element 104 with a sealing ring 406 place over the top perimeter edge of the venturi 402 (all show in FIGS. 4 and 6) to create a sealing system 210 for the upper support 106.

FIG. 2b is an enlarged view of the lower filter support system 108 of FIG. 2. The lower filter support 108 includes a filter cup 212 (or filter support member 212) with a high temperature gasket 214, for example, a glass gasket, for receiving the bottom of the filter element 104. The filter cup 212 is supported at its base by a post or pin like support structure 216 that extends from the bottom of the filter cup 212 through an opening in the lower support frame 206. A compression spring 220 is further positioned around the post 216 between the bottom of the filter cup 212 and the lower support frame 206 to provide a continuous upward force on the filter element 104 opposing the downward force of the filter element 104 to help seal the filter element 214 to the upper support system 106. The lower support frame 206 further includes a hollow pin guide 218 positioned in the opening of the lower support frame 206 for allowing the pin 216 to slide through the support frame 206 in response to movement in the compression spring 220.

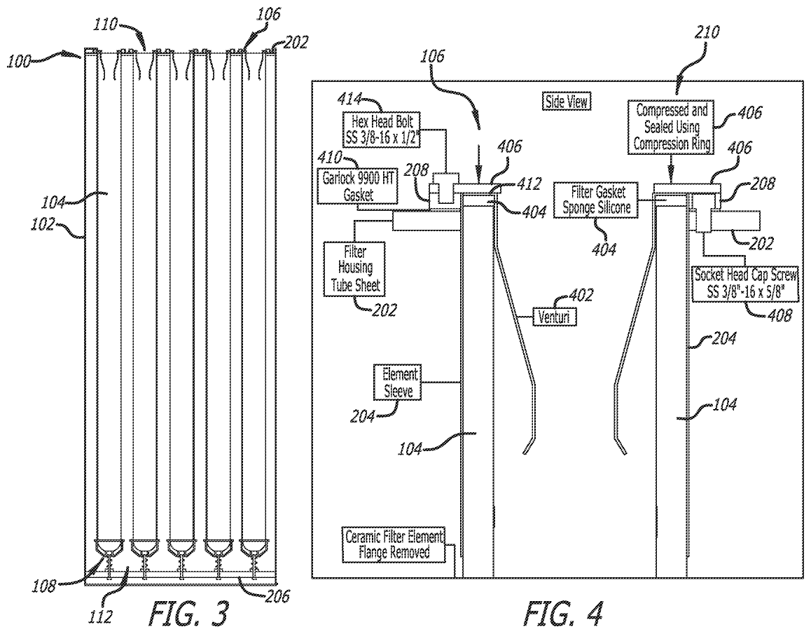

FIG. 3 illustrates an elevation view of another example of a filter support system 100 of the present invention incorporated into a filter housing 102 having one or more filter elements 104 positioned within the filter housing 102. In the illustrated example, five ceramic filter elements 104 are illustrated. Like in the filter support system 100 of FIG. 1, diesel exhaust is vented into the filter housing 102 and is filtered when passed through the filter elements 104. Treated exhausted gas then exits through the top 110 of the filter housing 102 and the waste material that cannot pass through the filter elements 104 is discharged through the bottom 112 of the filter housing 102. The filter elements 104 are supported within the filter housing 102 by an upper support system 106 and a lower support system 108.

FIG. 4 illustrates an enlarged view of the upper filter support system 106 of FIG. 3. As illustrated, the top of the filter element 104 is inserted into the hollow portion of the sleeve 204, which is designed to engage and maintain the top of each filter element 104. The support plate 202 includes openings, as will be better illustrated and described in connection with the FIG. 9 and FIG. 10 for receiving sleeves 204. The sleeves 204 each include an upper flange member 208 that extend outward from the sleeve 204 and surrounds the perimeter of the top opening of the sleeve 204. The upper flange member 208 rests on the top surface of the support plate 202 and includes screw holes for receiving screws 408 that align with screw holes in the support plate 202 to secure the upper flange member 208 of the sleeves 204 to the support plate 202. A sleeve gasket 410 may be placed between to upper flange member 208 and the top surface of the support plate 202 to help seal the upper flange member 208 to the support plate 202.

A filter gasket 404 that is of the same circumference as the filter element 104 is placed on the top of the filter element 104. The filter gasket 404 may be made of a sponge silicone or similar material. A venturi 402, having a top flange member 414, is then inserted into the central opening in the filter element 104. The venturi 402 is sealed to the filter element 104 by a compression ring 406. The compression ring 406 covers the top flange member 414 of the venturi 402 and the upper flange member 208 of the sleeve 204. Bolt holes in the compression ring 406 align with bolt holes in the upper flange member 208 of the sleeve 204 for receiving bolts 414 to seal the compression ring 406 against the top flange member 414 of the venturi 402 to the upper flange member 208 of the sleeve 204. The sealing system 210 includes the venturi 402 with filter gasket 404 placed on top of the filter element 104, with the venturi 402 inserted within the opening of the filter element 104. The sealing ring 406 placed over the top of the perimeter edge or top flange 414 of the venturi 402 creates the sealing system 210 for the upper support 106.

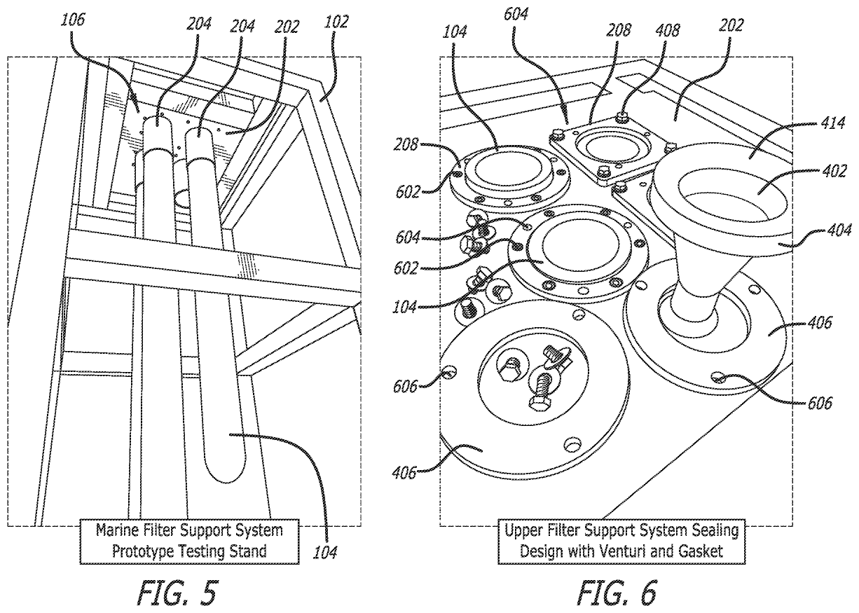

FIG. 5 is an image of one example of the bottom of the upper filter support system of the present invention. In this image, the support system for the filter housing 102 is shown. The support plate 202 includes four openings for receiving sleeves 204 that extend downward through the openings in the support plate 202. Each opening in the support plate 202 is sized to receive a sleeve 202. The sleeves 204 then engage the top of each filter element 104 within the sleeve 204 from under the support plate 202.

FIG. 6 is an image of one example of the top of the upper filter support system of the present invention. In FIG. 5, the upper flange member 208 of the sleeves 204 can be seen resting on the support plate 202. The top of each filter element 104 can be seen extending upward through the sleeves 204 in general alignment with the upper flange member 208. As shown, the flanges on the filter elements 104 are removed to reduce the space required by the filter at the tube sheet 202, increase filter element 104 count in the filter housing 102 and eliminate the most common filter element 104 fracture point.

The upper flange member 208 of the sleeves 204 includes first screw holes 602 for aligning with second screw holes in the support plate 202 for receiving a screw and securing the upper flange member 208 to the support plate 202. The upper flange member 208 further includes first bolt holes 604 for aligning with second bolt holes 606 in a sealing ring 406 to receive a bolt or screw 414 to secure the sealing ring 406 to the upper flange member 208 of the sleeve 204. To create a sealed system, a venturi 402 with a filter gasket 404 is placed in the top of each filter element 104 such that the gasket 404 rests on the top outer perimeter edge of the filter element 104. The filter gasket 404 is used to seal the filter element 104 at the tube sheet 202 and may be a high temperature specialty glass fiber gasket capable of withstanding high heat, up to and including 800 degrees Fahrenheit, or a sponge silicone gasket. The sealing ring 406 is then place over the top of the perimeter edge or top flange 414 of the venturi 402 (all show in FIG. 4) to create a sealing system for the upper support 106. The sealing ring 406 includes second bolt holes 606 corresponding to the first bolt holes 604 in the upper flange member 208 of the sleeve 202 for securing the sealing ring 406 to the upper flange member 208, using, for example, bolts, screws and/or washers 414. Similarly, screws 208 are inserted through the first screw holes 602 in the upper flange member 208 and the second screw holes in the support plate 202. The screws 408 may then be fastened to the underside of the support plate 202 with bolts. As shown, each filter element 104 is sealed separately. Using a single filter clamping system allows for a more robust clamping and sealing of each filter element 204 at the tube sheet 202 to maintain integrity.

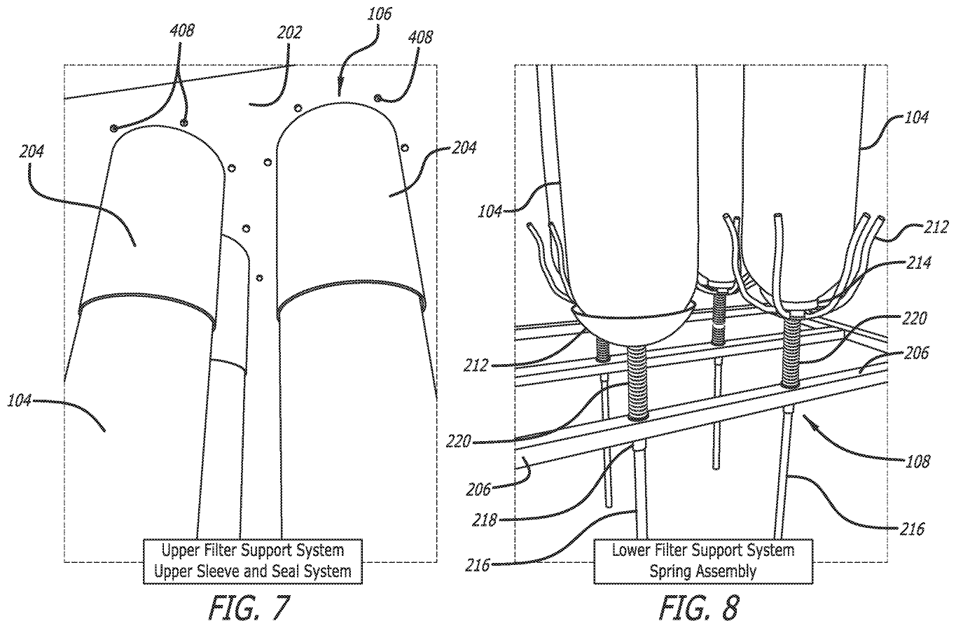

FIG. 7 is a close-up image of one example of the bottom of the upper filter support system 106 of the present invention. Here, the filter elements 104 are shown fitting within the sleeves 204 of the upper support system 106. Screws holes in the support plate 202 that correspond with the screw holes 602 in the upper flange member 208 of the sleeves 204 are shown with screws 408 extending therethrough to secure both the upper flange member 208 of the sleeves 204 to the support plate 202 with bolts.

FIG. 8 is an image of one example of the lower filter support system 108 of the present invention. As shown, the filter cup 212 or filter support member 212 may vary in construction. The filter cup 212 may be a solid cup shaped support or may be of an open construction, using, for example, finger like projections. The high temperature gasket 214 can be seen under the filter element 104 in the filter cup 212, which may be a glass fiber able to withstand high temperatures of at least and including 800 degrees Fahrenheit. The filter cup 212 can be seen supported at its base by a post, pole, pin or like support structure 216 that extends from the bottom of the filter cup 212 through a hollow pin guide 218 positioned in the opening of the lower support frame 206. The post, pole or pin may all be referred to as a post for purposes of this application. A compression spring 220 is positioned around the post 216 between the bottom of the filter cup 212 and the lower support frame 206. The compression spring 220 supports the filter element 104 against the upper support system 106.

FIG. 9 illustrates a plan view of one example of a tube sheet 202 of the present invention. As seen, the openings 900 in the tube sheet 202 can be in rows in direct alignment of one another. Alternatively, as illustrated in FIG. 10, which is a plan view of another example of a tube sheet 1002, the openings 1004 in the tube shape may be in rows where the openings are staggered or offset from one another. In this example, the multiple openings are arranged in rows and openings in each row are offset from immediately bordering rows (or offset from the rows directly next to each row).

A method for reducing damage to filter elements is also provided, the method includes the steps of supporting at least one filter element in a vertical orientation at both the top and bottom of the at least one filter element using an upper and lower support system. The method further includes the step of supporting the at least one filter element at its bottom with a compression spring that supports the at least one filter element against the upper support system, where the upper support system includes a sleeve for maintaining the top of the at least one filter element in a vertical orientation. The method further includes supporting and securing the filter elements using one or more of the structures taught in this application, including but not limited to sealing the top of the filter element using one or more of the structural elements taught in this application.

As illustrated and described above, the filter support system of the present invention reduces the footprint of a traditional filter housing. The support system of the present invention also minimizes the filter housing vibration caused by vessel operating machinery and reduces the risk of damage to the filters when the filter housing orientation changes when at sea. By supporting the vertical filters at both the top and the bottom, the impact of side forces applied to the filter housing with changing sea is greatly reduced, if not eliminated. Further, the upper and lower supports are capable of withstanding high temperatures, including and up to 800 degrees Fahrenheit.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

I claim:

1. A filter support system for reducing damage to filter elements, the filter support system comprising:
an upper support and lower support system for supporting at least one filter element in a vertical orientation by engaging a top and a bottom of the at least one filter element, where the upper support system includes a support sleeve for engaging the top of the at least one filter element and the lower support system includes a compression spring that supports the at least one filter element against the upper support system.

2. The filter support system of claim 1 where the lower support system further comprises:
a support frame;
a filter cup positioned above the support frame for supporting the bottom of the at least one filter element;
a post extending from a lower end of the filter cup through the support frame; and
a compression spring positioned around the post between the filter cup and the support frame.

3. The filter support system of claim 2 further including a high temperature gasket positioned in the filter cup for receiving the bottom of the at least one filter element.

4. The filter support system of claim 2 where the support frame includes an opening through which the post extends and where lower support system further includes a hollow pin guide positioned in the opening of the support frame for allowing the post to slide through the support frame in response to movement in the compression spring.

5. The filter support system of claim 1 where the upper support system further comprises:
a support plate having an opening for receiving the support sleeve, where the support sleeve includes a flange surrounding the perimeter of the top of the support sleeve for resting on a top surface of the support plate;
a sleeve gasket placed between the flange of the hollow filter support sleeve and the top surface of the support plate for sealing the flange member against the support plate.

6. The filter support system of claim 1 where the upper support system further includes a venturi positioned in a top opening of the support sleeve and having a venturi flange member for resting on a top perimeter edge of the at least one filter element when positioned in the support sleeve.

7. The filter support system of claim 1 where the at least one filter element has a top perimeter edge and the top perimeter edge of the filter element is positioned within the support sleeve, the upper support member further including a filter gasket placed on the top perimeter edge of the at least one filter element.

8. The filter support system of claim 7 where the upper support system further includes a venturi positioned in a top opening of the support sleeve and having a venturi flange member for resting on the filter gasket placed on the top perimeter edge of the at least one filter element.

9. The filter support system of claim 8 where the sleeve gasket is a silicon ring.

10. The filter support system of claim 7 where the upper support member further includes a compression ring securing the upper support system together.

11. A filter support system for supporting at least one filter element, the filter support system comprising:
an upper support system comprising:
a support plate having an opening for receiving a filter support sleeve having a flange surrounding the perimeter of the top of the filter support sleeve for resting on a top surface of the support plate;
a sleeve gasket placed between the flange of the filter support sleeve and the top surface of the support plate for sealing the flange member against the support plate; and
a venturi positioned in a top opening of the filter support sleeve for placement at least partially within the at least one filter element; and
a lower support comprising:
a support frame;
a filter cup positioned above the support frame for supporting the lower end of the filter element;
a post extending from the lower end of the filter cup through a support frame; and
a compression spring positioned around the post between the filter cup and the support frame.

12. The filter support system of claim 11 further including a high temperature gasket positioned in the filter cup for receiving the bottom of the at least one filter element.

13. The filter support system of claim 11 where the support frame includes an opening through which the post extends and where lower support system further includes a hollow pin guide positioned in the opening of the support frame for allowing the post to slide through the support frame in response to movement in the compression spring.

14. The filter support system of claim 11 where venturi further includes a venturi flange member for resting on a top perimeter edge of the at least one filter element when positioned in the filter support sleeve.

15. The filter support system of claim 11 where the at least one filter element has a top perimeter edge and the top perimeter edge of the filter element is positioned within the filter support sleeve, the upper support member further including a filter gasket placed on the top perimeter edge of the at least one filter element.

16. The filter support system of claim 15 where the venturi positioned in a top opening of the filter support sleeve has a venturi flange member for resting on the filter gasket placed on the top perimeter edge of the at least one filter element.

17. The filter support system of claim 11 where the sleeve gasket is a silicon ring.

18. The filter support system of claim 11 where the upper support member further includes a compression ring securing the upper support system together.

19. A filter support system for supporting at least one filter element, the filter support system comprising:
an upper support system comprising:
a support plate having an opening for receiving a filter support sleeve having a flange surrounding the perimeter of the top of the filter support sleeve for resting on a top surface of the support plate; and
a venturi positioned in the filter support sleeve for placement at least partially within the at least one filter element; and
a lower support comprising:
a support frame;
a filter support member for supporting the lower end of the filter element; and
a compression spring positioned between the filter support member and the support frame.

20. The filter support system of claim 19 where the support plate includes multiple openings for receiving a plurality of filter elements, where the multiple openings are arranged in rows and where the openings in each row are offset from immediately bordering rows.
